(19) United States
(12) Patent Application Publication
(10) Pub. No.: US 2019/0319436 A1
(43) Pub. Date: Oct. 17, 2019

(54) METHOD OF MANUFACTURING AN ELECTRICAL ASSEMBLY BY OVERPRINTING MATERIAL USING AN ADDITIVE MANUFACTURING PROCESS

(71) Applicant: Delphi Technologies, LLC, Troy, MI (US)

(72) Inventors: Eric J. Smoll, Fontana, CA (US); Bao Q. Le, Santa Ana, CA (US); Scott P. Cohen, Corona, CA (US); Gerald A. Rhinehart, Jr., Lordstown, OH (US)

(21) Appl. No.: 15/951,475

(22) Filed: Apr. 12, 2018

(51) Int. Cl. H02G 1/14; H01R 4/70; H01R 43/18; H02G 15/10; B33Y 10/00; B33Y 80/00; B29C 64/10

(52) U.S. Cl. CPC H02G 1/145; H01R 4/70; H01R 43/18; H02G 3/36; B33Y 10/00; B33Y 80/00; B29C 64/10; H02G 15/10

(57) ABSTRACT

A method of manufacturing an electrical assembly includes the step of forming an electrical circuit assembly having at least two terminating elements. The method further includes the step of forming a casing by overprinting a dielectric material over the electrical circuit assembly using an additive manufacturing process, thereby encapsulating a portion of the electrical circuit assembly. The terminating elements extend from the casing. The terminating elements are not overprinted with the dielectric material. The additive manufacturing process may be 3stereolithography, digital light processing, fused deposition modeling, fused filament fabrication, selective laser sintering, selecting heat sintering, multi-jet modeling, multi-jet fusion, electronic beam melting, laminated object manufacturing, or 3D printing.

### TECHNICAL FIELD OF THE INVENTION

The invention generally relates to method of manufacturing an electrical assembly by overprinting material using an additive manufacturing process.

### BRIEF DESCRIPTION OF THE SEVERAL VIEWS OF THE DRAWING

The present invention will now be described, by way of example with reference to the accompanying drawings, in which:

FIG. 1 is a flow chart of a method of manufacturing an electrical assembly, according to a first embodiment;

FIG. 2 is side view of an electrical assembly formed by the method of FIG. 1, according a second embodiment;

FIG. 3 is cross section side view of the electrical assembly of FIG. 2, according the second embodiment

FIG. 4 is perspective view of another electrical assembly formed by the method of FIG. 1, according a third embodiment;

FIG. 5 is perspective view of yet another electrical assembly formed by the method of FIG. 1, according a fourth embodiment;

FIG. 6 is perspective view of one more electrical assembly formed by the method of FIG. 1, according a fifth embodiment; and

FIG. 7 is cross section side view of the electrical assembly of FIG. 6, according the fifth embodiment.

### DETAILED DESCRIPTION OF THE INVENTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Presented herein is method of manufacturing an electrical assembly. The method includes the steps of forming an electrical circuit assembly having at least two terminating elements and forming a casing by overprinting a dielectric material over the electrical circuit assembly using an additive manufacturing process such as stereolithography, digital light processing, fused deposition modeling, fused filament fabrication, selective laser sintering, selecting heat sintering, multi-jet modeling, multi-jet fusion, electronic beam melting, laminated object manufacturing, or 3D printing, thereby encapsulating a portion of the electrical circuit assembly. The terminating elements extend from the casing. The terminating elements are not overprinted with the dielectric material.

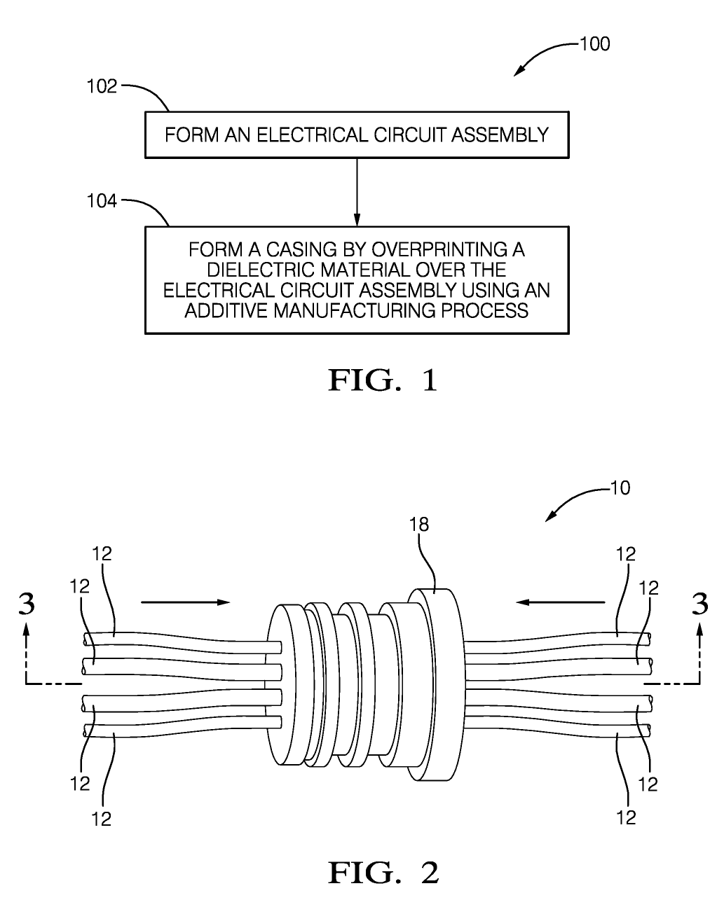

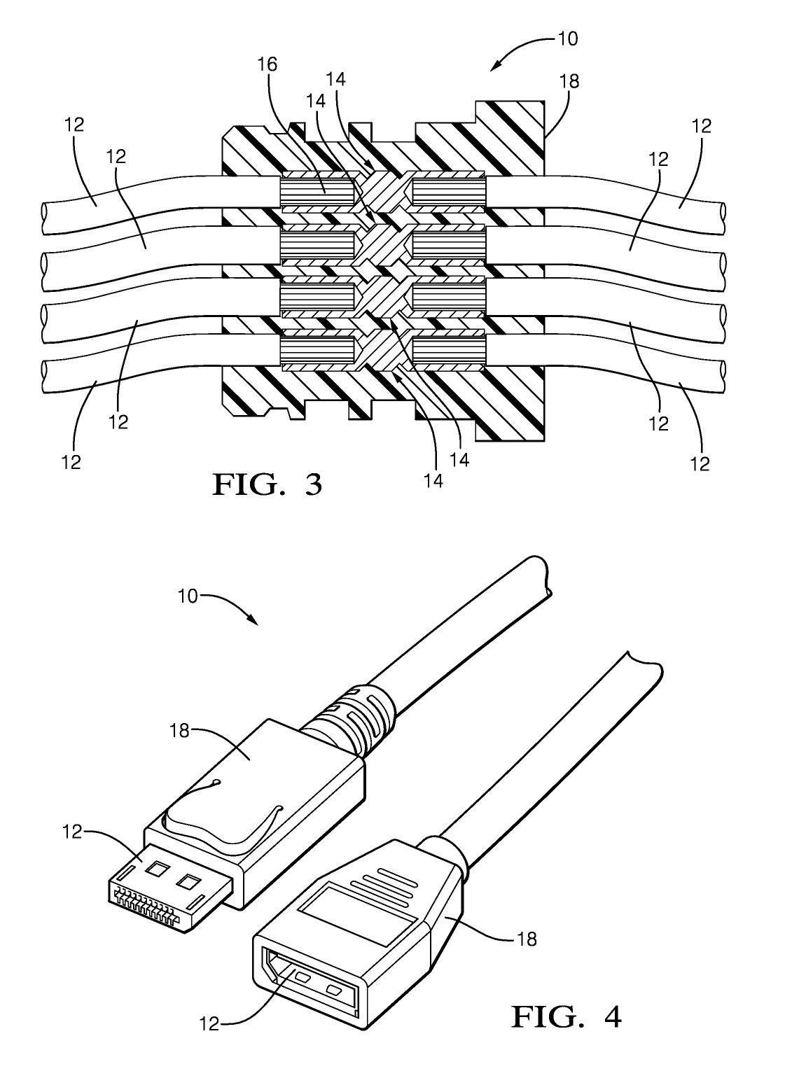

FIG. 1 describes a method 100 of manufacturing an electrical assembly, in this particular example a wire feed-through connector as shown in FIGS. 2 and 3. This connector assembly may be mounted within a wall or bulkhead in order to connect an electrical component on one side of the wall, e.g. a fuel level sensor, to another electrical component located on the other side of the wall, e.g. a fuel gauge. The method 100 includes the following steps:

STEP 102, FORM AN ELECTRICAL CIRCUIT ASSEMBLY, includes forming an electrical circuit assembly 10 having at least two terminating elements. In the example illustrated in FIG. 2, the electrical circuit assembly 10 consists of a pair of wires 12, i.e. the terminating elements, joined by a wire splice element 14 attached to an end of each of the wires 12. Without subscribing to any particular theory of operation, fluids or gasses may enter the wire through tears or openings in the outer covering of the wires 12 and flow though spaces or voids between the strands 16 of the wires 12. Because the ends of the wires 12 are separated, fluid or gasses entering one wire 12 cannot directly continue its flow path to enter the other wire 12; and

STEP 104, FORM A CASING BY OVERPRINTING A DIELECTRIC MATERIAL OVER THE ELECTRICAL CIRCUIT ASSEMBLY USING AN ADDITIVE MANUFACTURING PROCESS, includes forming a casing 18 around the electrical circuit assembly 10 by overprinting a dielectric material, e.g. a polyvinylchloride (PVC) or polytetrafluoroethylene (PTFE) material, over the electrical circuit assembly 10 using an additive manufacturing process, such as stereolithography, digital light processing, fused deposition modeling, fused filament fabrication, selective laser sintering, selecting heat sintering, multi-jet modeling, multi-jet fusion, electronic beam melting, laminated object manufacturing, or other processes generally referred to as 3D printing to form a connector body, thereby encasing or encapsulating a portion of the electrical circuit assembly 10. The terminating elements, i.e. wires 12, extend from the casing 18 and are not overprinted with the dielectric material.

FIG. 4 illustrates another example of an electrical circuit assembly 10, in this particular example a Universal Serial Bus (USB) connector in which the casing 18 is overprinted over the terminating elements, i.e. terminals 12, thereby encasing or encapsulating a portion of the electrical circuit assembly 10.

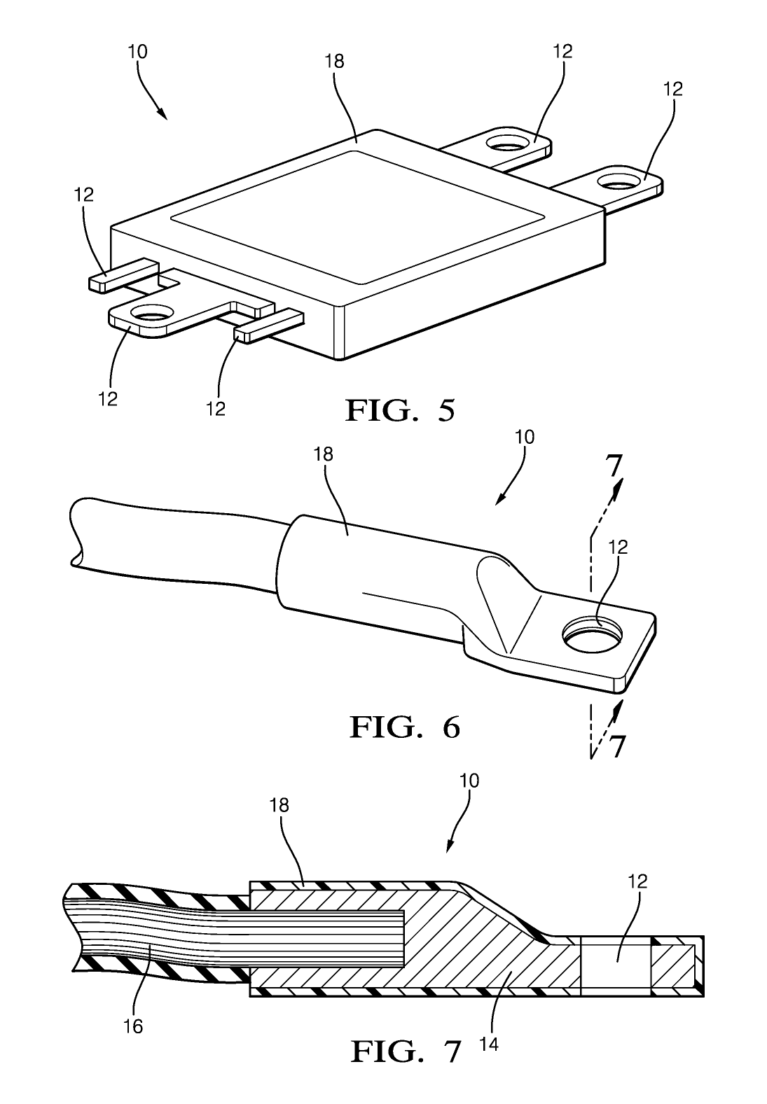

FIG. 5 illustrates yet another example of an electrical circuit assembly 10, in this particular example an integrated circuit assembly in which the casing 18 is overprinted over the integrated circuit (now shown) and the terminating elements, i.e. terminals 12, thereby encasing or encapsulating a portion of the electrical circuit assembly 10.

FIGS. 6 and 7 illustrates a further example of an electrical circuit assembly 10, in this particular example wire assembly having a wire 14 terminated by a terminal 12 which is foamed of a conductive material using one of the additive manufacturing processes listed above and casing 18 is overprinted over the terminal 12, thereby encasing or encapsulating a portion of the electrical circuit assembly 10.

As used herein “overprinting” refers to using an additive manufacturing process distinguished by computer controlled application of the dielectric material directly to the electrical circuit assembly 10 rather than using of a mold to contain material as it is injected or poured into the mold as is used in traditional encapsulating processes.

While the example presented herein is directed to a wire feed-through connector, alternative embodiments may be electrical circuit assemblies that include passive electrical components, such as resistors or capacitors, and/or active electrical components, such as transistors or diodes, and/or conductors such as stamped lead frames or conductive traces on a printed circuit board interconnecting the electrical components and providing the termination elements. Yet other alternative embodiments of the invention may include forming a casing using an additive manufacturing process to encapsulate mechanical or biological components.

Accordingly, a method 100 of manufacturing an electrical assembly is provided. The method 100 provides the benefit of avoiding stresses in the casing 18 that could cause damage to the electrical circuit assembly 10 that may be produced while forming the case using an injection molding process. The method 100 also avoids displacement of portions of the electrical circuit assembly 10 that could damage the electrical assembly caused by injecting material into a mold holding the electrical circuit assembly 10. The method 100 also reduces the occurrence of voids undesirably forming in the casing 18 that could occur in a molding process to form the casing 18.

While this invention has been described in terms of the preferred embodiments thereof, it is not intended to be so limited, but rather only to the extent set forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments, and are by no means limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

As used herein, ‘One or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. Moreover, the use of the terms first, second, etc. does not denote any order of importance, but rather the terms first, second, etc. are used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Additionally, directional terms such as upper, lower, etc. do not denote any particular orientation, but rather the terms upper, lower, etc. are used to distinguish one element from another and establish a relationship between the various elements.

We claim:

1. A method of manufacturing an electrical assembly, comprising the steps of:
forming an electrical circuit assembly having at least two terminating elements;
forming a casing by overprinting a dielectric material over said electrical circuit assembly using an additive manufacturing process, thereby encapsulating a portion of the electrical circuit assembly, wherein the at least two terminating elements extend from the casing.

2. The method according to claim 1, wherein the additive manufacturing process is selected from a list consisting of stereolithography, digital light processing, fused deposition modeling, fused filament fabrication, selective laser sintering, selecting heat sintering, multi-jet modeling, multi-jet fusion, electronic beam melting, laminated object manufacturing, and 3D printing.

3. The method assembly according to claim 2, wherein the at least two terminating elements are not overprinted with the dielectric material.

4. The method according to claim 1, wherein the steps of the method occur in the order listed.
